(19) United States
(12) Patent Application Publication
(10) Pub. No.: US 2024/0046905 A1
(43) Pub. Date: Feb. 8, 2024

(54) KEYBOARD APPARATUS

(71) Applicant: YAMAHA CORPORATION, Hamamatsu-shi (JP)

(72) Inventors: Akito OHBA, Hamamatsu-shi (JP); Yu YOSHIZAKI, Hamamatsu-shi (JP); Ryuichi ANZAI, Hamamatsu-shi (JP)

(21) Appl. No.: 18/465,453

(22) Filed: Sep. 12, 2023

Related U.S. Application Data
(63) Continuation of application No. PCT/JP2022/000723, filed on Jan. 12, 2022.

(30) Foreign Application Priority Data
Mar. 22, 2021 (JP) 2021-047712
Mar. 22, 2021 (JP) 2021-047713
Mar. 22, 2021 (JP) 2021-047714
Mar. 22, 2021 (JP) 2021-047717

(51) Int. Cl. G10H 1/34

(52) U.S. Cl. CPC G10H 1/346

(57) ABSTRACT

A keyboard apparatus, which can provide a keyboard apparatus that a size in depth direction is miniaturized, including a frame, a first member, a key, one or more hammer assemblies configured to rotate in accordance with movement of the key. The one or more hammer assemblies including a rotation member rotatably connected to the frame with respect to a rotation axis as a center of rotation and a weight member attached to the rotation member and having a first portion and a second portion. The second portion faces the first member in a first direction extending along the rotation axis, a thickness of the second portion is smaller than a thickness of the first portion in the first direction, and a length of the second portion is larger than a length of the first portion in a rotation direction of the weight member.

### CROSS-REFERENCE TO RELATED APPLICATIONS

This application is a Continuation of International Patent Application No. PCT/JP2022/000723, filed on Jan. 12, 2022, which claims the benefit of priority to Japanese Patent Application No. 2021-047712, filed on Mar. 22, 2021, Japanese Patent Application No. 2021-047713, filed on Mar. 22, 2021, Japanese Patent Application No. 2021-047714, filed on Mar. 22, 2021, and Japanese Patent Application No. 2021-047717, filed on Mar. 22, 2021, the entire contents of which are incorporated herein by reference.

### FIELD

An embodiment of the present disclosure relates to a keyboard apparatus. In particular, an embodiment of the present disclosure relates to a keyboard apparatus having a hammer assembly with different moments of inertia depending on keys.

### BACKGROUND

Conventional acoustic pianos, such as grand pianos and upright pianos, are composed of many components. In a conventional piano, a hammer assembly having a weight (hereinafter, referred to as a weight member) below a key is provided in order to give a sense (hereinafter, referred to as a touch feeling) to a finger of a player through the key (for example, Japanese Patent No. 2917863). In recent years, in order to realize a touch feeling similar to that of the conventional piano, an electronic keyboard apparatus has adopted a configuration in which a hammer assembly having different moments of inertia for keys belonging to different scales is used.

### SUMMARY

According to an embodiment of the present disclosure, a keyboard apparatus including a frame, a first member, a key, and one or more hammer assemblies configured to rotate in accordance with movement of the key. The one or more hammer assemblies including a rotation member rotatably connected to the frame with respect to a rotation axis as a center of rotation and a weight member attached to the rotation member and having a first portion and a second portion. The second portion faces the first member in a first direction extending along the rotation axis, a thickness of the second portion is smaller than a thickness of the first portion in the first direction, and a length of the second portion is larger than a length of the first portion in a rotation direction of the weight member.

According to an embodiment of the present disclosure, a keyboard apparatus including a frame, a first member, a key, and one or more hammer assemblies configured to rotate in accordance with movement of the key. The one or more hammer assemblies including a rotation member rotatably connected to the frame with respect to a rotation axis as a center of rotation and a weight member attached to the rotation member and having a first portion and a second portion. The second portion faces the first member in a first direction extending along the rotation axis, and the second portion has a shape that the first portion is collapsed in the first direction.

### BRIEF DESCRIPTION OF DRAWINGS

FIG. 1 is a diagram showing a configuration of a keyboard apparatus according to an embodiment of the present disclosure.

FIG. 2 is a block diagram showing a configuration of a sound source device according to an embodiment of the present disclosure.

FIG. 3 is an explanatory view of a configuration of inside of a housing when viewed from side according to an embodiment of the present disclosure.

FIG. 4 is a side view showing an example of different grade hammer assemblies according to an embodiment of the present disclosure.

FIG. 5A is a side view showing an example of different grade hammer assemblies according to an embodiment of the present disclosure.

FIG. 5B is a side view showing an example of different grade hammer assemblies according to an embodiment of the present disclosure.

FIG. 6 is a side view showing an example of different grade hammer assemblies according to an embodiment of the present disclosure.

FIG. 7 is a diagram showing a rotation surface of a center line of each weight member within a rotation range of a hammer assembly, with respect to weight members having different masses in the present embodiment.

FIG. 8A is a diagram showing an example of a hammer assembly according to an embodiment of the present disclosure.

FIG. 8B is a diagram showing an example of a hammer assembly according to an embodiment of the present disclosure.

FIG. 8C is a diagram showing an example of a hammer assembly according to an embodiment of the present disclosure.

FIG. 9 is a diagram showing an example of a hammer assembly according to an embodiment of the present disclosure.

FIG. 10 is a diagram of the present disclosure with a hammer assembly attached to a frame when viewed from above according to an embodiment of the present disclosure.

FIG. 11A is a diagram showing an example of a weight member according to an embodiment of the present disclosure.

FIG. 11B is a diagram showing an example of a weight member according to an embodiment of the present disclosure.

FIG. 11C is a diagram showing an example of a weight member according to an embodiment of the present disclosure.

FIG. 12 is a diagram of the present disclosure with a hammer assembly attached to a frame when viewed from above according to an embodiment of the present disclosure.

FIG. 13 is a diagram of the present disclosure with a hammer assembly attached to a frame when viewed from above according to an embodiment of the present disclosure.

FIG. 14 is a diagram of the present disclosure with a hammer assembly attached to a frame when viewed from above according to an embodiment of the present disclosure.

FIG. 15A is a diagram showing an example of a weight member according to an embodiment of the present disclosure.

FIG. 15B is a diagram showing an example of a weight member according to an embodiment of the present disclosure.

FIG. 16A is a diagram showing a step of resin-molding a weight support member into a weight member according to an embodiment of the present disclosure.

FIG. 16B is a diagram showing a step of resin-molding a weight support member into a weight member according to an embodiment of the present disclosure.

### DESCRIPTION OF EMBODIMENTS

Hereinafter, a keyboard apparatus according to an embodiment of the present disclosure will be described in detail with reference to the drawings. The following embodiments are examples of embodiments of the present disclosure, and the present disclosure should not be construed as being limited to these embodiments. In the drawings referred to in the present embodiment, the same or similar parts are denoted by the same reference signs or similar reference signs (only denoted by A, B, etc. after the numerals), and repeated description thereof may be omitted. Dimensional ratios (ratios between components, ratios in vertical and horizontal height directions, and the like) in the drawings may be different from actual ratios for convenience of explanation, and a part of configurations may be omitted from the drawings. In the following description, based on the vertical direction in each drawing, although there may be expressed as “above”, “upward”, “upper end”, “below”, “lower”, and “lower end”, these vertical directions only explain relationships of relative directions, the vertical directions may be reversed. In addition, a configuration in which moments of inertia of hammer assemblies differ depending on keys may be referred to as a configuration in which grades of the hammer assemblies differ.

In the case of a keyboard apparatus as disclosed in Japanese Patent No. 2917863, since an elongated rod-shaped weight member is used, there is a limit to a reduction of the keyboard apparatus in a depth direction of a hammer assembly. If the keyboard apparatus is reduced in the depth direction, the weight member needs to be thickened in order to secure a mass of the weight member. Further, if the keyboard apparatus is reduced in the depth direction, arrangement positions of members such as ribs and bosses provided in a frame are limited. Due to this influence, the ribs and the bosses need to be placed between adjacent hammer assemblies. Under such conditions, if the weight member becomes thicker, the hammer assembly and the rib or the boss interfere with each other.

It is an object of an embodiment of the present disclosure to provide a keyboard apparatus in which a size in a depth direction is reduced.

### 1. First Embodiment

### [1-1. Configuration of Keyboard Apparatus]

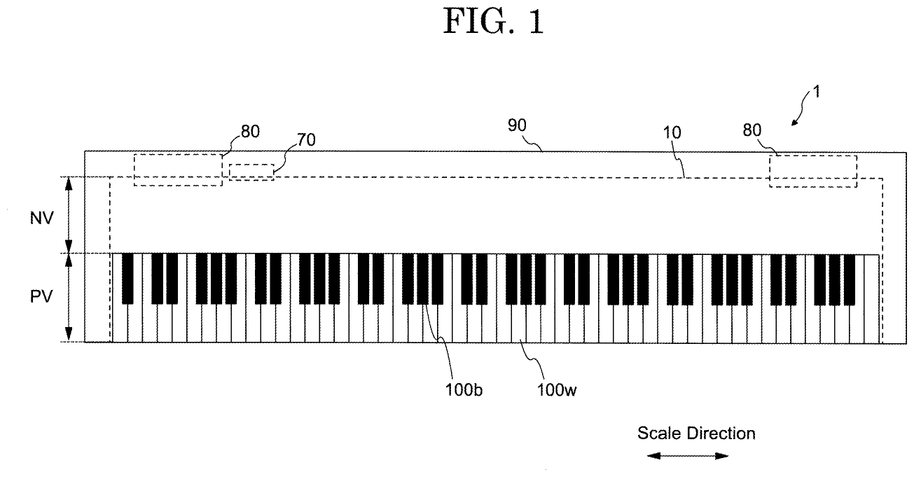

FIG. 1 is a diagram showing a configuration of a keyboard apparatus according to a first embodiment. A keyboard apparatus 1 is, for example, an electronic keyboard musical instrument such as an electronic piano that generates a sound in response to a depression by a user (a player). The keyboard apparatus 1 may be a keyboard-type controller that outputs control data (for example, a MIDI) for controlling an external sound source device in response to a key depression. In this case, the keyboard apparatus 1 may not include a sound source device.

The keyboard apparatus 1 includes a keyboard assembly 10. Keyboard assembly 10 includes a white key 100w and a black key 100b. In the case where the white key 100w and the black key 100b do not need to be distinguished, they are simply referred to as a key 100. The white key 100w and the black key 100b are arranged side by side. The number of keys 100 is N, N is 88 in this example. A direction in which these keys 100 are arranged is referred to as a scale direction. In the following description, a configuration in which a reference sign (numeral) is followed by “w” means a configuration corresponding to a white key. A configuration in which a reference sign (numeral) is followed by “b” means a configuration corresponding to a black key.

A portion of the keyboard assembly 10 exists within a housing 90. In the case where the keyboard apparatus 1 is viewed from above, a portion of the keyboard assembly 10 covered by the housing 90 is referred to as a non-appearance portion NV, and a portion exposed from the housing 90 and visible to the user is referred to as an appearance portion PV. That is, the appearance portion PV is a portion of the key 100 and indicates an area in which the user can perform a performance operation. Hereinafter, the portion of the key 100 exposed by the appearance portion PV may be referred to as a key body portion.

A sound source device 70 and a speaker 80 are disposed inside the housing 90. The sound source device 70 generates a sound waveform signal with a depression of the key 100. The speaker 80 outputs the sound waveform signal generated by the sound source device 70 to an external space. The keyboard apparatus 1 may include a slider for controlling volume, a switch for switching tone, a display for displaying various information, and the like.

In the description of the present specification, directions such as above, below, left, right, front, and rear indicate directions in the case where the keyboard apparatus 1 is viewed from a player when playing. For example, it can be expressed that the non-appearance portion NV is located at a rear side of the appearance portion PV. In some cases, the direction is indicated with respect to the key 100, such as a key front end side (key front side) and a key rear end side (key rear side). In this case, the key front end side indicates a front side of the key 100 as viewed from the player. The key rear end side indicates a rear side of the key 100 as viewed from the player. According to this configuration, in the black key 100b, it is possible to express that a front end to a rear end of a key body unit of the black key 100b is a portion protruding upward from the white key 100w.

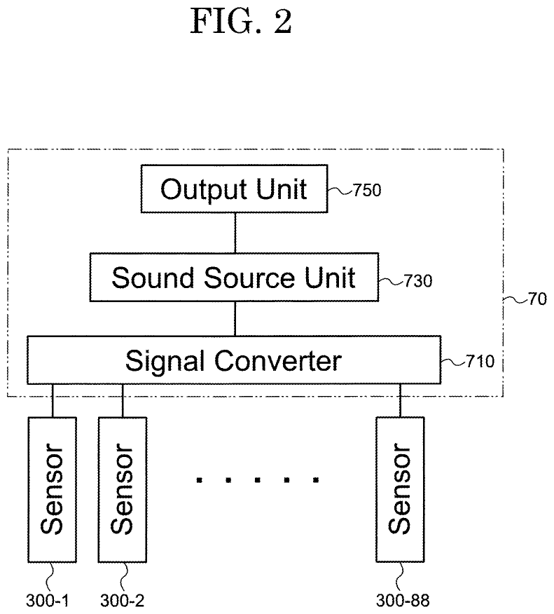

FIG. 2 is a block diagram showing a configuration of a sound source device according to the first embodiment. The sound source device 70 includes a signal conversion unit 710, a sound source unit 730, and an output unit 750. A sensor 300 is provided corresponding to each key 100, detects an operation of the key, and outputs a signal corresponding to the detected content. In this example, the sensor 300 outputs signals according to key depression amount of three steps. Key depression speed can be detected in accordance with intervals of the signals.

The signal conversion unit 710 acquires output signals of the sensors 300 (the sensors 300-1, 300-2, . . . , 300-88 corresponding to 88 keys 100), and generates and outputs operation signals corresponding to the operation states of the respective keys 100. In this example, the operation signal is a signal in a MIDI format. In response to key depression operation, the signal conversion unit 710 outputs note-on. At this time, a key number indicating which of the 88 keys 100 is operated and a velocity corresponding to the key depression speed are output in association with the note-on. On the other hand, in response to a key release operation, the signal conversion unit 710 outputs the key number and note-off in association with each other. A signal corresponding to other operations such as a pedal may be input to the signal conversion unit 710 and reflected in the operation signal.

The sound source unit 730 generates a sound waveform signal based on the operation signal output from the signal conversion unit 710. The output unit 750 outputs the sound waveform signal generated by the sound source unit 730. The sound waveform signal is output to, for example, the speaker 80 or a sound waveform signal output terminal.

### [1-2. Keyboard Assembly Configuration]

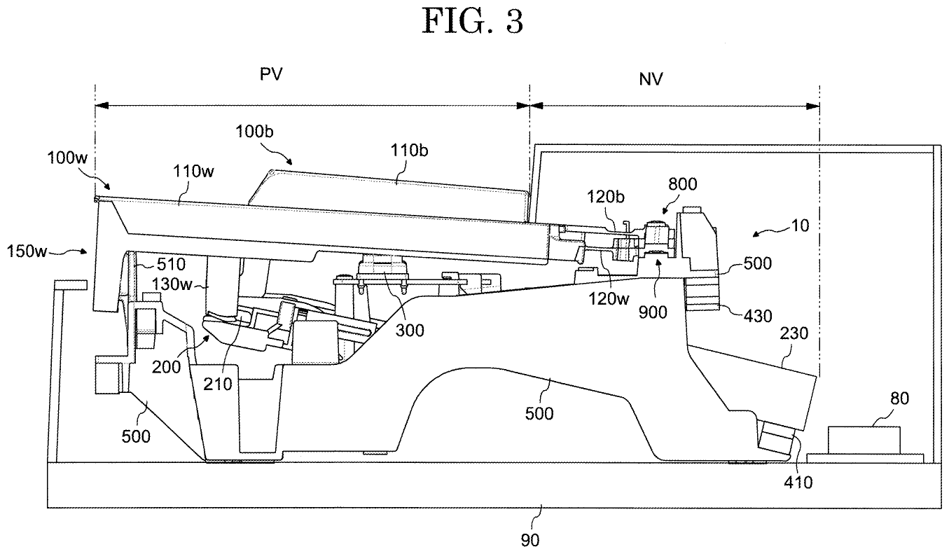

FIG. 3 is an explanatory view of a configuration inside a housing according to the first embodiment when viewed from side. In the following explanation, although the white key 100w will be described as an example, a hammer assembly 200 according to the present embodiment may be used for the black key 100b, and is not limited to the hammer assembly 200 used for the white key 100w. As shown in FIG. 3, the keyboard assembly 10 and the speaker 80 are disposed inside the housing 90. The speaker 80 is disposed on a rear side of the keyboard assembly 10. The speaker 80 is arranged so as to output a sound corresponding to the key depression upward and downward from the housing 90. The sound output downward travels from a lower surface side of the housing 90 to an outside. On the other hand, the sound output upward passes through a space inside the keyboard assembly 10 from an inside of the housing 90, and proceeds to the outside from the gap between the adjacent white keys 100w or the gap between the white key 100w and the housing 90 in the appearance portion PV.

A configuration of the keyboard assembly 10 will be described with reference to FIG. 3. The keyboard assembly 10 includes the hammer assembly 200, a frame 500, a connecting portion 800, and a mounting portion 900 in addition to the white key 100w and the sensor 300 described above. The keyboard assembly 10 is a structure made of resin in which most of components are manufactured by injection molding or the like. The frame 500 is fixed to the housing 90. The mounting portion 900 is fixed to the frame 500. The connecting portion 800 is attached to the mounting portion 900 and connects the white key 100w to the frame 500 in a rotatable manner. The white key 100w includes a key body unit 110w and a key support unit 120w. The key body unit 110w is connected to the connecting portion 800 via the key support unit 120w. The key support unit 120w is a plate-shaped member. A portion of the key support unit 120w is thinner in thickness than other portions and has a flexibility. The flexibility causes the portion of the key support unit 120w to bend, thereby causing the white key 100w to rotate with respect to the frame 500.

The white key 100w comprises a front end key guide 150w. The front end key guide 150w slidably contacts a front end frame guide 510 while covering the front end frame guide 510 of the frame 500. The front end key guide 150w contacts the front end frame guide 510 on both scaled sides of upper and lower portions thereof. On the other hand, a member corresponding to the front end key guide 150w is not provided in the black key 100b.

The hammer assembly 200 is rotatably attached to a shaft portion provided in the frame 500. As will be described in detail later, a bearing member 220 provided in the hammer assembly 200 is rotatably attached to the shaft portion. The shaft portion may be referred to as a fixing member fixed to the frame 500. The bearing member 220 may be referred to as a rotating member that is rotatably connected to the fixing member. A front end member 210 of the hammer assembly 200 contacts a hammer support unit 130w so as to be slidable generally in a front-rear direction in an inner space of the hammer support unit 130w in the white key 100w. The sliding portion, i.e., a portion where the front end member 210 and the hammer support unit 130w are contacted, is located below the white key 100w in the appearance portion PV (forward of a rear end of the key body unit 110w).

The hammer assembly 200 includes a weight member 230 made of metal on a rear side of a rotation axis of the hammer assembly 200. In a normal state (when the key is not pressed), the weight member 230 is placed on a lower stopper 410, and the front end member 210 of the hammer assembly 200 pushes the white key 100w upward. When the key is pressed, the weight member 230 moves upward and collides with an upper stopper 430. That is, the hammer assembly 200 rotates in response to a movement of the white key 100w. With this weight member 230, the hammer assembly 200 provides a weight for the key depression. The lower stopper 410 and the upper stopper 430 are formed of a cushioning material or the like (a nonwoven fabric, an elastic body, or the like).

The sensor 300 is attached to the frame 500 below the key body unit 110w. When the sensor 300 is crushed on the lower surface of the key body unit 110w by the key depression, the sensor 300 outputs a detection signal. As described above, the sensor 300 is provided corresponding to each key 100.

As described above, in the present embodiment, although the configuration in which the bearing member 220 provided in the hammer assembly 200 is rotatably attached to a shaft portion provided in the frame 500 is shown, a member corresponding to the shaft portion may be provided in the hammer assembly 200, and a member corresponding to the bearing member 220 may be provided in the frame 500.

### [1-3. Configuration of Hammer Assembly 200]

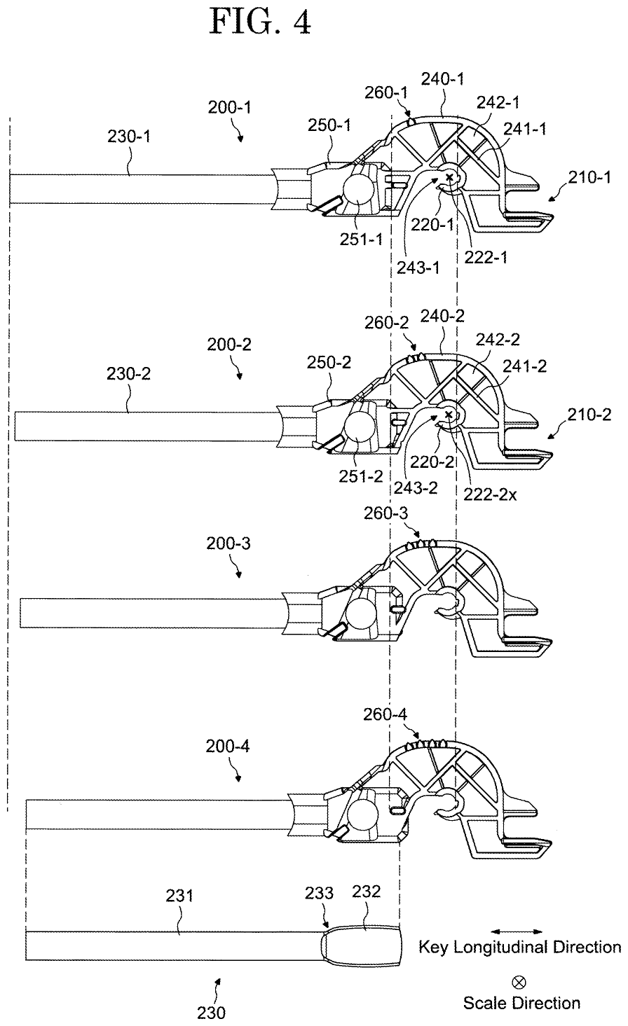

FIG. 4 is a side view showing an example of different grade hammer assemblies according to an embodiment of the present disclosure. As shown in FIG. 4, the hammer assembly 200 includes the front end member 210, the bearing member 220, the weight member 230, a body member 240, a weight support member 250, and a marker member 260. In FIG. 4, four types of hammer assemblies 200 are shown. Depending on the type of hammer assembly 200, hammer assemblies 200-1, 200-2, 200-3, 200-4 are shown. In the following description, in the case where each hammer assembly 200 is described separately, branch numbers such as “−1” are given after the reference signs of the hammer assembly 200 and the respective members constituting the hammer assembly 200. On the other hand, in the case where it is not necessary to distinguish each hammer assembly 200, the branch number is not assigned, and it is simply referred to as a hammer assembly 200.

The body member 240 is a member that constitutes a main portion of the hammer assembly 200 except for the weight member 230 and functions as a frame of the hammer assembly 200. The body member 240 includes a rib 241 and a concave portion 242. A rigidity of the body member 240 is secured by the rib 241, and a weight of the body member 240 is reduced by the concave portion 242. In addition, a presence of the concave portion 242 improves an ease of resin molding of the body member 240. The rib 241 extends in a direction inclined with respect to a direction in which the weight member 230 extends. However, the direction in which the rib 241 extends may not be inclined with respect to the direction in which the weight member 230 extends.

The front end member 210 is slidably attached to the hammer support unit 130w as described above. The front end member 210 protrudes from the body member 240 in a direction away from the bearing member 220. The front end member 210 has upwardly and downwardly bifurcated protrusions, and the hammer support unit 130w slides in a grooved part between the two protrusions.

The bearing member 220 has a shape that can be attached to the shaft portion. Specifically, the bearing member 220 is constituted by an arcuate inner wall, and is provided with an opening 243 for attachment to the shaft portion. In the case where the hammer assembly 200 is attached to the shaft portion, the hammer assembly 200 moves so that the shaft portion reaches the bearing member 220 through the opening 243. In addition, the bearing member 220 is attached to the shaft portion in a snap-fit manner. That is, a width of an opening end portion of the bearing member 220 is smaller than a diameter of the shaft portion.

The weight support member 250 is provided on a side opposite to the front end member 210 with respect to the bearing member 220. In the present embodiment, the weight support member 250 protrudes from the body member 240 in a direction opposite to the front end member 210. The weight support member 250 fixes the weight member 230 in a state of covering a portion of the weight member 230. The weight support member 250 is resin-molded in a state in which the weight member 230 is disposed inside the weight support member 250. In the hammer assemblies 200-1 to 200-4, weight support members 250-1 to 250-4 have different shapes because the positions of the weight members 230 with respect to the respective weight support members 250 are different. The weight support member 250 is provided with concave portions 251. The concave portions 251 are provided at two positions so as to sandwich the weight member 230. The resin molding is performed in a state where the weight member 230 is sandwiched between the concave portions 251 during the resin molding.

The weight member 230 is fixed to the weight support member 250 and extends in a direction away from the body member 240. That is, the weight member 230 has a rod-shape. The weight member 230 is shown in a state removed from the weight support member 250 under the four hammer assemblies 200-1 to 200-4 of FIG. 4. The weight member 230 includes a first portion 231 and a second portion 232. In the present embodiment, all of the second portion 232 and a portion of the first portion 231 are covered by the weight support member 250. Although a detailed configuration of the weight member 230 will be described later, the first portion 231 has a length in a longitudinal direction of the key 100. A cross-sectional shape of the first portion 231 orthogonal to the longitudinal direction is circular. That is, the first portion 231 has a cylindrical shape. The second portion 232 has a shape in which the first portion 231 is collapsed.

Although the configuration in which the cross-sectional shape of the first portion 231 is circular has been exemplified in the present embodiment, the configuration is not limited to this configuration. For example, the cross-sectional shape may be rectangular, other polygonal, or elliptical. The cross-sectional shape of the first portion 231 being rod-shaped means the first portion 231 has a longitudinal shape and the cross-sectional shape of the first portion 231 is a circular shape, a square shape, a rectangle shape having a ratio [short side/long side] of 3/4 or more and less than 1, or a ratio [first side/second side] of a first side and a second side orthogonal to each other in a rectangle circumscribing the cross-sectional shape is 3/4 or more and 4/3 or less. On the other hand, a case other than the above is referred to as a plate shape. That is, the cross-sectional shape of the second portion 232 being plate-shaped means a case where the cross-sectional shape of the second portion 232 is a rectangle having a ratio [short side/long side] of less than 3/4, or the ratio [first side/second side] of the first side and the second side of a rectangle circumscribing the cross-sectional shape is less than ¾ or greater than 4/3.

A cross-sectional shape (a shape of the cross section orthogonal to the longitudinal direction) of the weight member 230 at any plurality of points in the longitudinal direction is the same except for the second portion 232, which will be described in detail later. In other words, the cross-sectional shape of the weight member 230 at any plurality of points in the longitudinal direction is the same in an area of more than half the length of the weight member 230 with respect to a total length in the longitudinal direction. Additionally, in other words, in the longitudinal direction of the weight member 230, the cross-sectional shape of the weight member 230 at any plurality of points in the longitudinal direction is the same in an area excluding an area having a length of 10% with respect to the total length of the weight member 230 from both end portions of the weight member 230. In other words, the cross-sectional shape of the weight member 230-1 exposed from the weight support member 250-1 is substantially uniform in the longitudinal direction of the weight member 230-1. As will be described in detail below, since the shape of the second portion 232 is a collapsed shape of the first portion 231, a cross-sectional area (a cross-sectional area orthogonal to any plurality of points in the longitudinal direction) of the weight member 230 (including the first portion 231 and the second portion 232) at any plurality of points in the longitudinal direction is the same. In other words, the first portion 231 and the second portion 232 have the same cross-sectional area.

In the case where a maximum length in the cross section orthogonal to the longitudinal direction of the weight member 230 (for example, a length of a diagonal line in the case where the cross-sectional shape is rectangular) and the total length in the longitudinal direction of the weight member 230 are compared, in the case where a ratio of the total length in the longitudinal direction to the maximum length in the cross section (that is, the maximum length in the total length/cross section) is 2.5 or more, there is a case where the cross-sectional shape is a rod shape even if [first side/second side] is smaller than ¾ or larger than 4/3.

In the hammer assemblies 200-1 to 200-4, there is no difference in the shape of the weight member 230. That is, each of the weight members 230-1 to 230-4 has the same shape. Similarly, each of the weight members 230-1 to 230-4 has the same material. As a result of the same shape and material, the weight members 230-1 to 230-4 have the same mass. Thus, for example, weight member 230-1 may be used with other hammer assemblies 200-2 to 200-4.

On the other hand, positions where the weight members 230-1 to 230-4 are attached to the weight support members 250-1 to 250-4 are different from each other. As shown in FIG. 4, a position corresponding to an end of the second portion 232 (a position of a right end of the weight support member 250) approaches the bearing member 220 in an order of the hammer assemblies 200-1, 200-2, 200-3, and 200-4. That is, a right end of the weight member 230-2 is closer to the bearing member 220 than a right end of the weight member 230-1. A right end of the weight member 230-3 is closer to the bearing member 220 than the right end of the weight member 230-2. A right end of the weight member 230-4 is closer to the bearing member 220 than the right end of the weight member 230-3. That is, the weight support members 250-1 to 250-4 have different shapes.

With the above configuration, the position of the tip (left end) of the weight member 230 approaches a center of rotation 222 in the order of the hammer assemblies 200-1, 200-2, 200-3, and 200-4. That is, a position of a center of gravity of the weight member 230 approaches the bearing member 220 in the order of the hammer assemblies 200-1, 200-2, 200-3, and 200-4. Specifically, a distance between a center of gravity of the weight member 230-1 and a center of rotation 222-1 is different from a distance between a center of gravity of the weight member 230-2 and a center of rotation 222-2. As a result, a moment of inertia of each of the hammer assemblies 200-1 to 200-4 is different. As described above, since the shape and mass of each of the weight members 230-1 to 230-4 are the same, the center of gravity of each of the weight members 230-1 to 230-4 itself is the same, but the moment of inertia of each of the hammer assemblies 200-1 to 200-4 is different depending on the position where the weight members 230-1 to 230-4 are attached.

The first portion 231 has a cylindrical shape having a longitudinal axis. The second portion 232 has a flat plate shape having a main surface facing the scale direction. A width of the second portion 232 in an up-down direction is larger than a width of the first portion 231 in the up-down direction. The second portion 232 has a collapsed shape of the first portion 231. The second portion 232 is covered by the weight support member 250. The weight support member 250 covers a border portion 233 between the second portion 232 and the first portion 231.

Since the weight member 230 has the flat second portion 232, a rotation of the weight member 230 about the longitudinal direction of the weight member 230 is restricted. That is, the second portion 232 and the weight support member 250 covering the second portion function as a stopper for restricting the rotation of the weight member 230. The weight support member 250 covering the border portion 233 restricts the weight member 230 from moving away from the bearing member 220. That is, the border portion 233 and the weight support member 250 covering the border portion 233 function as a stopper for restricting the movement of the weight member 230.

The hammer assembly 200 rotates about the center of rotation 222. The hammer assemblies 200-1 to 200-4 are used depending on a scale of the white key 100w. Alternatively, the hammer assemblies 200-1 to 200-4 are used depending on a scale of the black key 100b. That is, different hammer assemblies 200-1 to 200-4 are not used between the white key 100w and the black key 100b, but different hammer assemblies 200-1 to 200-4 are used in a plurality of white key 100w or a plurality of black key 100b.

The marker member 260 is provided at an upper portion of the body member 240. Marker members 260-1 to 260-4 provided in each of the hammer assemblies 200-1 to 200-4 have different shapes. Specifically, the marker member 260-1 has one protrusion, the marker member 260-2 has two protrusions, the marker member 260-3 has three protrusions, and the marker member 260-4 has four protrusions. Hammer assemblies 200 having the same moment of inertia are provided with the same marker member 260, and hammer assemblies 200 having different moments of inertia are provided with different marker members 260. That is, the operator can recognize the type of the hammer assembly 200 based on a number of protrusions provided on the marker member 260.

Although the weight members 230-1 to 230-4 have the same shape in the present embodiment, some or all of the shapes of the weight members 230-1 to 230-4 may be different. Although the weight members 230-1 to 230-4 are made of the same material in the present embodiment, some or all of the weight members 230-1 to 230-4 may be made of different materials. Although a configuration in which the weight members 230-1 to 230-4 are rod-shaped has been exemplified in the present embodiment, the weight members 230-1 to 230-4 may have shapes other than rod-shaped as an example will be described later. Although a configuration in which the shapes of the weight support members 250-1 to 250-4 are different has been shown in the present embodiment, some or all of the weight support members 250-1 to 250-4 may have the same configuration.

As described above, according to the hammer assembly 200 of the present embodiment, a plurality of hammer assemblies 200 having different moments of inertia can be realized by using the same weight member 230. As a result, since it is not necessary to prepare the weight member 230 that is different for each hammer assembly 200, it is possible to realize a keyboard apparatus having a small manufacturing cost and a small workload.

### [1-4. Modification]

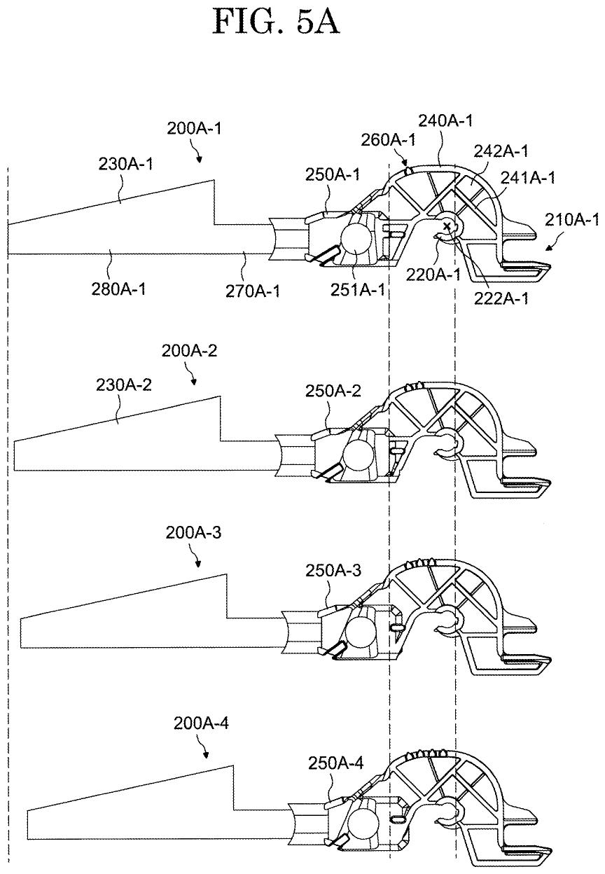

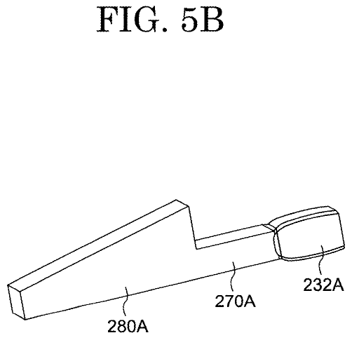

A modification of the first embodiment will be described with reference to FIG. 5A and FIG. 5B. FIG. 5A and FIG. 5B are a side view showing an example of a different grade hammer assemblies according to an embodiment of the present disclosure. Although the hammer assembly 200A shown in FIG. 5A is similar to the hammer assembly 200 shown in FIG. 4, the hammer assembly 200A differs from the hammer assembly 200 in that the shape of the weight member 230A differs from the shape of the weight member 230. In the following description, features similar to those of the hammer assembly 200 of FIG. 4 will be omitted, and differences from the hammer assembly 200 will be mainly described. In addition, in the following description, the same configuration as in the other embodiments will be described with reference to FIG. 1 to FIG. 4, and an alphabet “A” is attached after the reference numerals shown in these figures.

As shown in FIG. 5B, the weight member 230A has a plate shape. The weight member 230A can be formed by sheet metal processing or the like. In the embodiment of FIG. 5A and FIG. 5B, the shape of the weight member 230A is a shape in which a trapezoidal 1-2 portion 280A is provided at a distal end of a rectangular 1-1 portion 270A when viewed in the scale direction. A second portion 232A is provided opposite to the 1-2 portion 280A with respect to the 1-1 portion 270A. The shape of the second portion 232A is a shape in which a portion of the 1-1 portion 270A is collapsed. In addition, the example of FIG. 5A and FIG. 5B is merely an example, and a plate-like member other than the shapes shown in FIG. 5A and FIG. 5B can be used as the weight member 230A.

In the hammer assemblies 200A-1 to 200A-4, the shapes of the weight members 230A-1 to 230A-4 do not differ. That is, the respective shapes of the weight members 230A-1 to 230A-4 are the same. Similarly, each material of the weight members 230A-1 to 230A-4 is the same. As a consequence of the similar shapes and materials, masses of each of the weight member 230A-1 to 230A-4 are the same. Thus, for example, the weight member 230A-1 can be used in other hammer assemblies 200A-2 to 200A-4. On the other hand, as in FIG. 4, positions at which the weight members 230A-1 to 230A-4 are attached to the weight support members 250A-1 to 250A-4 differ from each other. Consequently, a moment of inertia of each of the hammer assemblies 200A-1 to 200A-4 differs.

As described above, according to the modification of the first embodiment, a plurality of hammer assemblies 200A having differing moments of inertia can be realized by using the same weight member 230A. Therefore, the weight member 230A does not need to be prepared for each hammer assembly 200A, and therefore, a keyboard apparatus having a small manufacturing cost and a small workload can be realized.

### 2. Second Embodiment

### [2-1. Configuration of Hammer Assembly 200B]

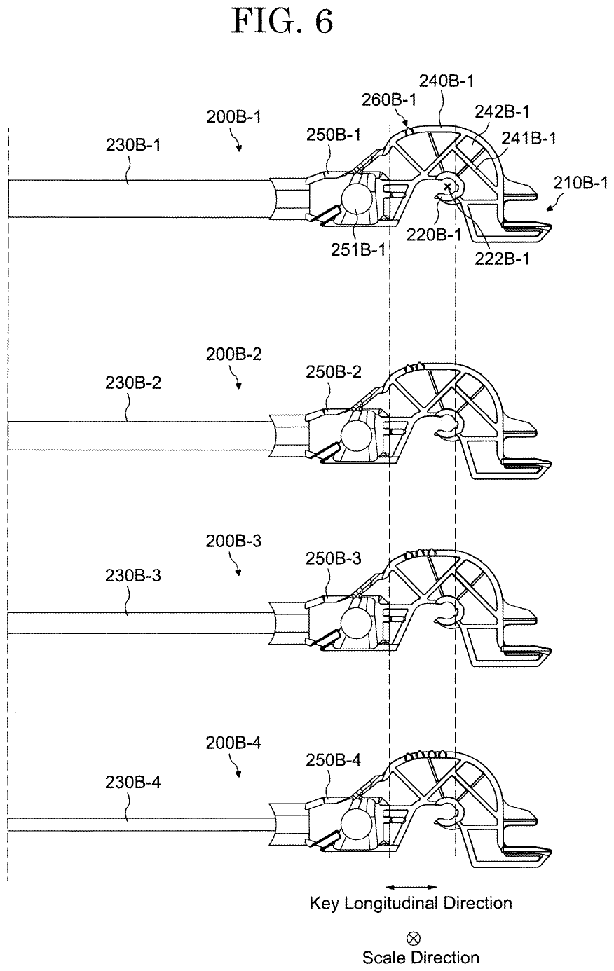

A second embodiment will be described with reference to FIG. 6. FIG. 6 is a side view showing an example of different grade hammer assemblies according to an embodiment of the present disclosure. A hammer assembly 200B shown in FIG. 6 is similar to the hammer assembly 200 shown in FIG. 4, but shapes of weight members 230B-1 to 230B-4 of the hammer assembly 200B are different from the shapes of the weight members 230-1 to 230-4 of the hammer assembly 200. In the following description, features similar to those of the hammer assembly 200 of FIG. 4 will be omitted, and differences from the hammer assembly 200 will be mainly described. In addition, in the following description, the same configuration as in the other embodiments will be described with reference to FIG. 1 to FIG. 5B, and an alphabet “B” is attached after the reference numerals shown in these figures.

The hammer assembly 200B rotates about a center of rotation 222B. The hammer assemblies 200B-1 to 200B-4 are used depending on a scale of a white key 100wB. Alternatively, the hammer assemblies 200B-1 to 200B-4 are used depending on a scale of a black key 100bB. That is, in a plurality of white keys 100wB or a plurality of black keys 100bB, different hammer assemblies 200B-1 to 200B-4 are used instead of different hammer assemblies 200B-1 to 200B-4 being used between the white key 100wB and the black key 100bB.

As shown in FIG. 6, in the longitudinal direction of the key 100B, positions at which the weight members 230B-1 to 230B-4 are respectively attached to weight support members 250B-1 to 250B-4 are the same. That is, positions of end portions of the weight support members 250B-1 to 250B-4 in the longitudinal direction of the key 100B are the same. In the longitudinal direction of the key 100B, positions of distal ends of the weight members 230B-1 to 230B-4 are the same. On the other hand, diameters (thicknesses) of the weight members 230B-1 to 230B-4 are different. In other words, cross-sectional areas of the weight members 230B-1 to 230B-4 in the cross-section perpendicular to the extension direction are different. Specifically, the cross-sectional area of the weight member 230B-1 perpendicular to the extending direction of the weight member 230B-1 is substantially uniform in the extending direction. Similarly, the cross-sectional area of the weight member 230B-4 perpendicular to the extending direction of the weight member 230B-4 is substantially uniform in the extending direction. In addition, the extending direction means a direction perpendicular to a cross section in a direction in which a cross-sectional area is minimized at any position of the weight member 230B, as will be described later.

In other words, the cross-sectional area of the weight member 230B-1 perpendicular to the extending direction of the weight member 230B-1 exposed from the weight support member 250B-1 is substantially uniform in the extending direction of the weight member 230B-1. Similarly, the cross-sectional area of the weight member 230B-4 perpendicular to the extending direction of the weight member 230B-4 exposed from the weight support member 250B-4 is substantially uniform in the extending direction of the weight member 230B-4.

Since the weight members 230B-1 to 230B-4 are made of the same material, weights of the weight members 230B-1 to 230B-4 differ depending on the diameters (thicknesses) and the cross-sectional areas. The diameter (thickness) means a diameter in the case where the cross-sectional shape of the weight member 230B is circular, and means a largest width in a cross-sectional shape in the case where the weight member 230B is not circular.

The weight member 230B in the present embodiment has a configuration in which a cross-sectional area at any plurality of points in the longitudinal direction is uniform in each of the weight members 230B-1 to 230B-4 (that is, a configuration in which a diameter at any plurality of points in the longitudinal direction is constant). In the case where each of the weight members 230B-1 to 230B-4 is formed, each weight member 230B can be obtained by cutting out a predetermined length from one rod-shaped base body.

In other words, the cross section perpendicular to the extending direction of the weight member 230B can be referred to as a cross section in a direction in which the cross-sectional area is minimized at a position other than the end portion in the longitudinal direction of the weight member. For example, in the case where the weight member 230B is curved, the cross-sectional direction for evaluating the cross-sectional area is not a constant direction at all times, but a cross-section in a direction in which the cross-sectional area is minimized at the position. That is, in the case where the weight member 230B is curved, the direction of the cross section for evaluating the cross-sectional area varies depending on the position of the weight member 230B in the extending direction. In other words, the extending direction means a direction perpendicular to the cross section in a direction in which the cross-sectional area is minimized at any position of the weight member 230B.

While the weight members 230B-1 to 230B-4 have differing cross-sectional areas, each of the weight members 230B-1 to 230B-4 is substantially uniform in cross-sectional area at any plurality of points along its length. Therefore, in the longitudinal direction of the key 100B, the position of the center of gravity of each of the weight members 230B-1 to 230B-4 is substantially the same. For example, the distance between the center of gravity of the weight member 230B-1 and a center of rotation 222B-1 is the same as a distance between a center of gravity of the weight member 230B-2 and a center of rotation 222B-2.

As described above, since the weights of the weight members 230B-1 to 230B-4 are different, a moment of inertia of each of the hammer assemblies 200B-1 to 200B-4 is different. Shapes of the weight members 230B-1 to 230B-4 are the same as or similar to the shape of the weight member 230 shown in FIG. 4. That is, each of the weight members 230B-1 to 230B-4 has a first portion 231B and a second portion 232B, similar to the weight member 230 shown in FIG. 4.

In the present embodiment, although a configuration in which a position of the center of gravity of each of the weight members 230B-1 to 230B-4 is substantially the same in the longitudinal direction of the key 100B is shown, the position of the center of gravity of each of the weight members 230B-1 to 230B-4 may be different. For combinations in which the positions of the center of gravity are different among the weight members 230B-1 to 230B-4, masses may be the same. Some or all of the weight members 230B-1 to 230B-4 may be made of different materials.

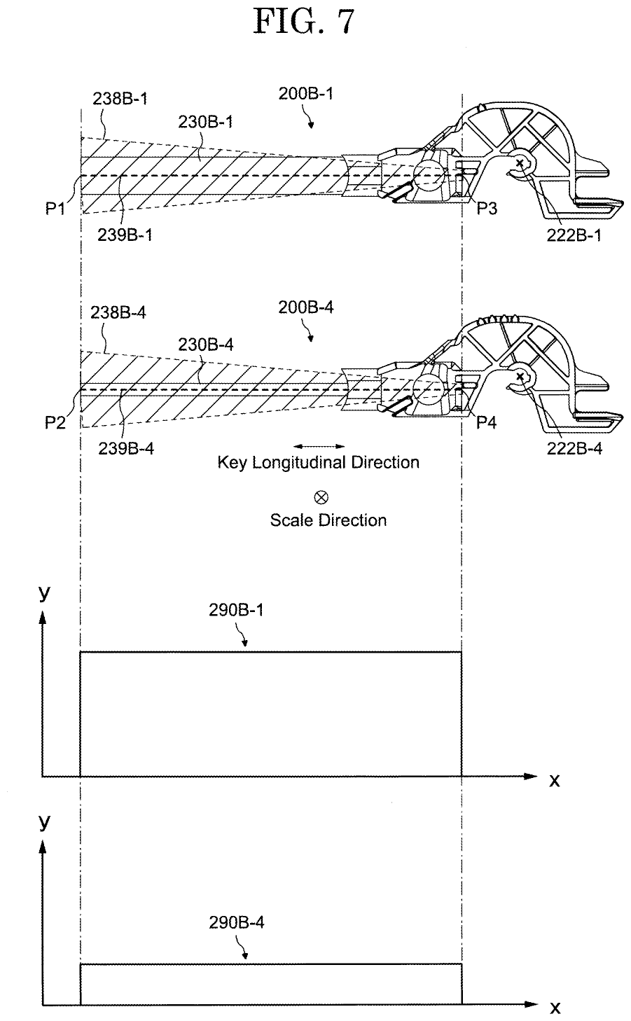

FIG. 7 is a diagram showing a rotation surface (or a rotation trajectory) of a center line of the weight members in a rotation range of the hammer assembly 200B in the weight members 230B-1 and 230B-4 according to the present embodiment. Center lines 239B-1 and 239B-4 of each of the weight member 230B-1 and 230B-4 are indicated by a dotted line. In the case where the hammer assembly 200B is rotated, rotational planes 238B-1 and 238B-4 drawn by these center lines are indicated by hatching of hatched lines. In the case where the hammer assembly 200B is viewed in the scale direction, the rotational planes 238B-1 and 238B-4 overlap and outer edges of each of the rotational planes 238B-1 and 238B-4 are approximately coincident. In other words, the rotational plane 238B-1 and the rotational plane 238B-4 have substantially the same shapes.

In the case where the hammer assembly 200B is viewed in the scale direction, a tip P1 of the center line 239B-1 substantially overlaps (coincides with) a tip P2 of the center line 239B-4. The tips P1 and P2 are distal ends of the weight member 230B-1 and 230B-4 farther from the centers of rotation 222B-1 and 222B-4. As described above, when the hammer assembly 200B is viewed in the scale-direction, a front end P3 of the center line 239B-1 substantially overlaps (coincides with) a front end P4 of the center line 239B-4. The distal ends P3 and P4 are distal ends of the weight members 230B-1 and 230B-4 closer to the center of rotation 222B-1.

In FIG. 7, the longitudinal direction of the key 100B is defined as an x-axis, and linear densities of the weight members 230B-1 and 230B-4 are defined as a y-axis. A graph 290B-1 shows the linear density of the weight member 230B-1, and a graph 290B-4 shows the linear density of the weight member 230B-4. A function describing the graph 290B-1 is a function obtained by multiplying a function describing the graph 290B-4 by a constant.

In the embodiment shown in FIG. 7, although a configuration in which the graphs 290B-1 and 290B-4 of the area corresponding to the weight members 230B-1 and 230B-4 are straight lines is shown, the configuration is not limited to this configuration. For example, these graphs may be curves.

As described above, according to the hammer assembly 200B of the present embodiment, the plurality of hammer assemblies 200B having different moments of inertia can be realized by preparing weight members 230B having different cross-sectional areas.

In the case where a plurality of hammer assemblies having different moments of inertia is formed by adjusting lengths of the weight members, it is necessary to cut and shorten a tip or a root of the weight member. When the distal end side of the weight member is shortened, the stopper (the stopper corresponding to the lower stopper 410 and the upper stopper 430) provided in the frame needs to be arranged in accordance with the shortest weight member. The stopper is provided in common to the plurality of hammer assemblies. Therefore, in the case where the stopper is disposed as described above, in the longest weight member, a distal end of the weight member is located at a position beyond the stopper. As a result, when the weight member collides with the stopper, the portion of the weight member from the portion that collides with the stopper to the tip vibrates, thereby causing vibration of the entire weight member. On the other hand, in the case where the root side of the weight member is shortened, it is necessary to design the shape of the weight support member for supporting the weight member in accordance with the weight member, in order to form such a weight support member, a mold for separate resin molding is required.

By using the weight member 230B according to the present embodiment, the above-described disadvantages can be solved.

According to the configuration of the present embodiment, it is possible to balance touch feelings between the case where the player weakly hits the key 100B and the case where the player hits the key strongly, among the different key 100B. That is, a ratio of the touch feelings in the case where the hammer assemblies 200B-1 and 200B-4 are weakly struck with the same force is substantially the same as a ratio of the touch feelings in the case where the hammer assemblies 200B-1 and 200B-4 are strongly struck with the same force. For example, in the case where the weight is weakly struck with the same force, when a ratio between a weight received by a performer by the hammer assembly 200B-1 and a weight received by the performer by the hammer assembly 200B-4 is three times, a ratio of the weight described above is three times in the case where the weight is strongly struck with the same force. More specifically, according to the configuration described above, relative ratios of balances of static moments of inertia (static touch feeling) and reaction forces (dynamic touch feeling) generated when the rotation of the hammer assembly 200B is accelerated due to the moments of inertia can be made similar between the keys 100B belonging to each of the hammer assemblies 200B-1 and 200B-4.

### 3. Third Embodiment

### [3-1. Configuration of Hammer Assembly 200D]

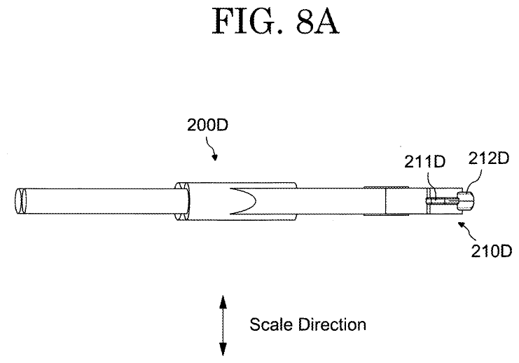

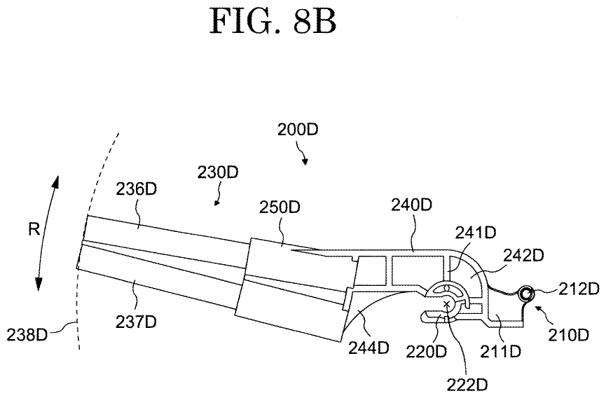

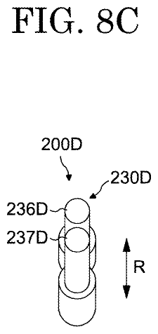

A third embodiment will be described with reference to FIG. 8A to FIG. 8C. FIG. 8A to FIG. 8C are a diagram showing an example of a hammer assembly according to an embodiment of the present disclosure. A hammer assembly 200D shown in FIG. 8A to FIG. 8C is similar to the hammer assembly 200 shown in FIG. 4, but is different from the hammer assembly 200 in that one hammer assembly 200D is provided with a plurality of weight member 230D. In the following description, features similar to those of the hammer assembly 200 of FIG. 4 will be omitted, and differences from the hammer assembly 200 will be mainly described. In the following description, the same configuration as in the other embodiments will be described with reference to FIG. 1 to FIG. 7, and an alphabet “D” is attached after the reference signs shown in these figures.

As shown in FIG. 8B and FIG. 8C, the weight member 230D of the hammer assembly 200D includes a first weight member 236D and a second weight member 237D. The hammer assembly 200D is rotatably attached to a shaft portion of a frame 500D by a bearing member 220D. The first weight member 236D and the second weight member 237D are provided on the opposite side of the hammer assembly 200D with respect to a center of rotation 222D of the hammer assembly 200D from a portion where a key 100D acts on the hammer assembly 200D (a front end member 210D). By a rotation of the hammer assembly 200D, the weight member 230D is rotated in a rotation direction (R direction) of the weight member 230D. A rotational plane of the first weight member 236D formed by the rotation overlaps with a rotational plane of the second weight member 237D. That is, the first weight member 236D is provided in a rotational plane 238D of the second weight member 237D. In other words, the first weight member 236D and the second weight member 237D vertically overlap each other when a keyboard apparatus 1D is played. However, the first weight member 236D and the second weight member 237D may not overlap vertically in this condition.

In the present embodiment, the first weight member 236D and the second weight member 237D are both rod-shaped (cylindrical), and shapes thereof are the same. The first weight member 236D and the second weight member 237D are fixed in a weight support member 250D. At the time of depressing of the key, a direction in which the first weight member 236D pushes the upper stopper 430 while the first weight member 236D contacts the upper stopper 430D (see FIG. 3) is a direction perpendicular to a longitudinal direction of the first weight member 236D. Similarly, at the time of releasing the key, a direction in which the second weight member 237D pushes the lower stopper 410D while the second weight member 237D contacts the lower stopper 410D (see FIG. 3) is a direction perpendicular to a longitudinal direction of the second weight member 237D.

The first weight member 236D and the second weight member 237D are arranged such that a distance between the weight members are reduced from the weight support member 250D toward distal ends of the weight members. According to such an arrangement, the first weight member 236D and the second weight member 237D can be firmly held in the weight support member 250D, and an occupied area can be reduced in a vicinity of the distal end of these weight members. In addition, in the present embodiment, the longitudinal direction of the first weight member 236D and the longitudinal direction of the second weight member 237D are non-parallel to each other.

As described above, since a configuration in which the first weight member 236D is provided in the rotational plane 238D of the second weight member 237D is realized, the weight support member 250D is provided on the side of a body member 240D, and a portion thereof protrudes downward. A rib 244D is provided for connecting the weight support member 250D and the body member 240D.

Unlike the front end member 210 shown in FIG. 4, the front end member 210D has a connecting member 211D and a locking member 212D. The connecting member 211D connects the body member 240D and the locking member 212D. The connecting member 211D has a plate shape. The locking member 212D is provided at an end portion of the connecting member 211D. The locking member 212D protrudes from the plate-shaped connecting member 211D toward the scale. The locking member 212D of the front end member 210D slides relative to the inner wall of the hammer support unit 130w (see FIG. 3), so that the hammer assembly 200D rotates in response to the movement of the key 100D. In addition, in the case where a hammer assembly 200D as shown in FIG. 8A to FIG. 8C is used, the shape of the inner wall of the hammer support unit 130w is designed in accordance with a shape of the front end member 210D.

In the present embodiment, although a configuration in which both the first weight member 236D and the second weight member 237D are cylindrical is shown, the configuration is not limited to this configuration. For example, each of the first weight member 236D and the second weight member 237D may be shaped such that a portion of an area covered by the weight support member 250D is collapsed as in the weight member 230 shown in FIG. 4. Alternatively, as shown in FIG. 4, in the different hammer assemblies 200D, the moments of inertia may be configured to differ depending on the hammer assemblies 200D in positions where one or both of the first weight member 236D and the second weight member 237D are attached to the weight support members 250D. Alternatively, as shown in FIG. 5A and FIG. 5B, the largest cross-sectional areas of one or both of the first weight member 236D and the second weight member 237D may be different in the different hammer assemblies 200, and the moments of inertia may be different depending on the hammer assemblies 200D.

Further, in the present embodiment, although the configuration in which the first weight member 236D and the second weight member 237D are respectively rod-shaped has been exemplified, the configuration is not limited thereto. As will be described later, the first weight member 236D and the second weight member 237D may not be rod-shaped. If the first weight member 236D and the second weight member 237D are rod-shaped, they may be parallel. As described above, the shape of the first weight member 236D may be different from the shape of the second weight member.

As described above, according to the hammer assembly 200D of the present embodiment, since a length of the hammer assembly 200D in the longitudinal direction of the key 100D can be shortened, a space-saving in the depth direction of the keyboard apparatus 1D can be realized. If the same weight member can be used for the first weight member 236D and the second weight member 237D, it is possible to realize a keyboard apparatus having a small manufacturing cost and a small workload.

### [3-2. Modification]

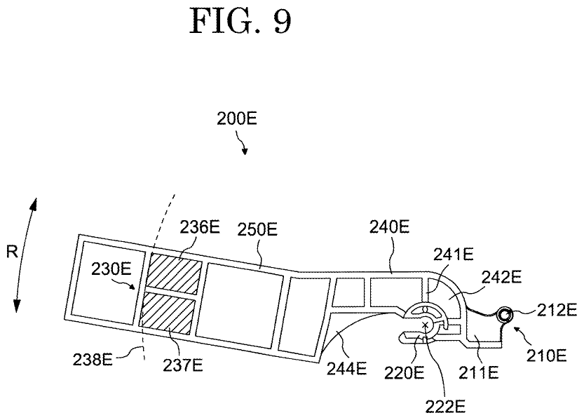

A modification of the third embodiment will be described with reference to FIG. 9. FIG. 9 is a diagram showing an example of a hammer assembly according to an embodiment of the present disclosure. Although a hammer assembly 200E shown in FIG. 9 is similar to the hammer assembly 200D shown in FIG. 8A to FIG. 8C, the hammer assembly 200E is different from the hammer assembly 200D in that the shapes of the first weight member 236D and the second weight member 237D are not rod-shaped. In the following description, features similar to those of the hammer assembly 200D of FIG. 8A to FIG. 8C will be omitted, and differences from the hammer assembly 200D will be mainly described. In the following description, the same configuration as in the other embodiments will be described with reference to FIG. 1 to FIG. 8C, and an alphabet “E” is attached after the reference signs shown in these figures.

As shown in FIG. 9, a weight member 230E of the hammer assembly 200E includes a flat plate-shaped first weight member 236E and a second weight member 237E. As in FIG. 8A to FIG. 8C, the first weight member 236E is provided in a rotational plane 238E of the second weight member 237E. The first weight member 236E and the second weight member 237E may be provided, for example, in a concave portion 242E surrounded by a rib 241E. Alternatively, an opening portion may be provided instead of the concave portion 242E, and a weight member may be provided in the opening portion.

As described above, according to the modification of the third embodiment, since a length of the hammer assembly 200E in a longitudinal direction of a key 100E can be shortened, a space-saving in a depth direction of a keyboard apparatus 1E can be realized.

In FIG. 8A to FIG. 8C and FIG. 9, although a configuration in which the first weight members 236D and 236E and the second weight members 237D and 237E are provided opposite to a portion (front end members 210D and 210E) where the keys 100D and 100E act on the hammer assemblies 200D and 200E with respect to centers of rotation 222D and 222E of the hammer assemblies 200D and 200E is shown, the configuration is not limited to this configuration. For example, the first weight member 236D, the second weight member 237D, and the portion where the key 100D acts on the hammer assembly 200D may be provided on the same side with respect to the center of rotation 222D. That is, the key 100D may act on the hammer assembly 200D between the two weight members 236D and 237D and the center of rotation 222D.

### 4. Fourth Embodiment

### [4-1. Configuration of Hammer Assembly 200F]

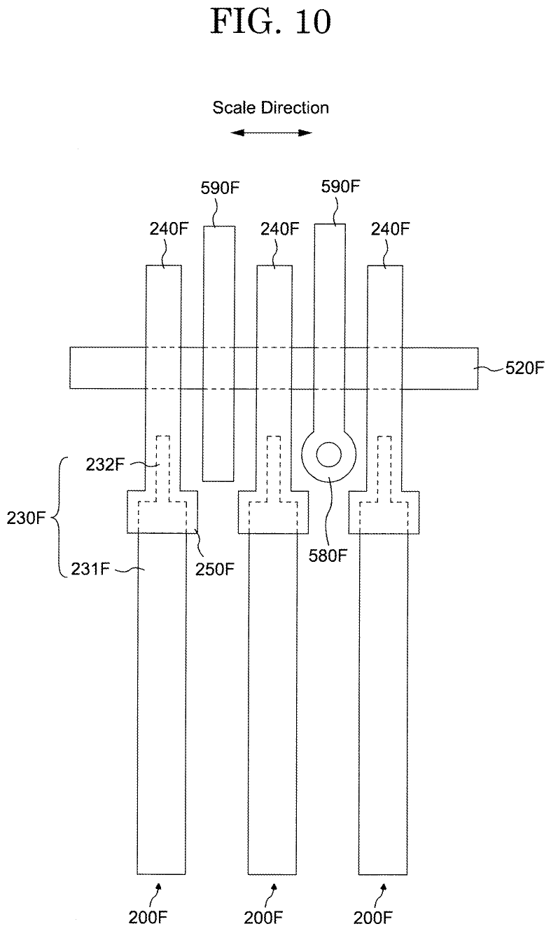

A fourth embodiment will be described with reference to FIG. 10. FIG. 10 is a top view of an embodiment of the present disclosure with a hammer assembly attached to a frame. A hammer assembly 200F shown in FIG. 10 is a cross-sectional view from above with the hammer assembly 200-1 shown in FIG. 4 attached to the frame 500. In the following description, features similar to those of the hammer assembly 200 of FIG. 4 will be omitted, and features not described in the first embodiment will be described. In the following description, the same configuration as in the other embodiments will be described with reference to FIG. 1 to FIG. 9, and an alphabet “F” is attached after the reference signs shown in these figures.

As shown in FIG. 10, the hammer assembly 200F is attached to an axis portion 520F. The axis portion 520F extends in a scale direction (sometimes referred to as a “first direction”). A plurality of hammer assemblies 200F (weight member 230F) is adjacent to each other in the scale direction. A plurality of ribs 590F is adjacent to each other in a scaled manner. The rib 590F and a boss 580F are provided between the adjacent hammer assemblies 200F. The weight member 230F provided in the hammer assembly 200F includes a first portion 231F and a second portion 232F. In the following explanation, at least one of the adjacent rib 590F and the boss 580F may be referred to as a “first member”.

In the scale direction, a width of the second portion 232F is smaller than a width of the first portion 231F. As will be described later, the second portion 232F is shaped such that the first portion 231F is collapsed in the scale direction. The first portion 231F does not face the first member (rib 590F and boss 580F), and the second portion 232F faces the first member. In other words, the first member is provided in an area sandwiched by the second portions 232F adjacent the scale direction. On the other hand, the first member is not provided in an area sandwiched by the first portion 231F adjacent the scale direction. In other words, although the second portion 232F and the first member overlap each other when viewed in the scale direction, the first portion 231F and the first member do not overlap each other. It is not required that the above relationship be satisfied between all the hammer assemblies 200F and the first members, and the above relationship be satisfied between at least a part of the hammer assemblies 200F and the first members.

The rib 590F and the boss 580F (first member) may be a portion of a frame 500F, that is, may be integrally formed with the frame 500F, or may be a member fixed to the frame 500F by bonding or the like. In the embodiment of FIG. 10, the boss 580F is provided at one end of the two ribs 590F. However, the boss 580F may be provided at both ends of the two ribs 590F. In the scale direction, a width of the boss 580F is greater than a width of the rib 590F. A weight support member 250F covers all of the second portion 232F and a portion of the first portion 231F.

In other words, it can be said that a portion of the weight member 230F between the adjacent rib 590F (first member) is collapsed in the scale direction (first direction). In other words, the second portion 232F corresponding to a portion of the weight member 230F between the adjacent rib 590F has a smaller scale direction thickness than the first portion 231F. According to this configuration, a thickness of the weight support member 250F in an area corresponding to the second portion 232F is smaller than a thickness of the weight support member 250F in an area corresponding to the first portion 231F in the scale direction.

In the keyboard apparatus 1F, the rib 590F for improving a strength of the frame 500F or the boss 580F used for connecting to another member may be provided at a position adjacent the key 100F. With a reduction of the keyboard apparatus 1F, if a space in which the rib 590F and the boss 580F are arranged is limited, there is a case where the rib 590F and the boss 580F need to be arranged at a position adjacently to the key 100F. Even in such cases, the configuration described above can prevent the weight member 230F from interfering with the key 100F while securing the weight.

In addition, in the present embodiment, although the rib 590F and the boss 580F adjacent to the weight member 230F in the scale direction correspond to the first member, the configuration is not limited thereto. For example, the first member may be a member that sandwiches the weight member 230F vertically. That is, the weight member 230F may be provided between the first member and the second member vertically.

### [4-2. Configuration of Weight Member 230F]

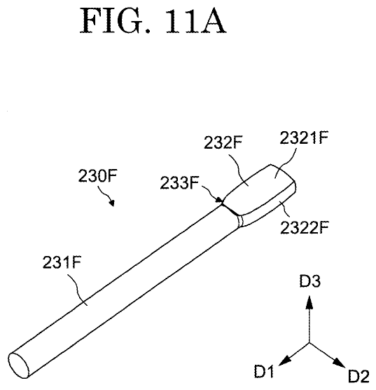

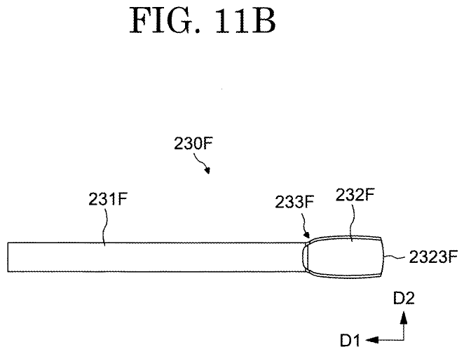

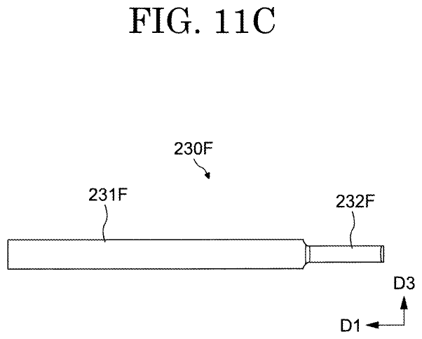

FIG. 11A to FIG. 11C are a diagram showing an example of a weight member according to an embodiment of the present disclosure. As shown in FIG. 11A to FIG. 11C, the weight member 230F has the first portion 231F and the second portion 232F. The first portion 231F is rod-shaped, in particular cylindrical. The second portion 232F has a flat plate shape. The second portion 232F is formed by collapsing a portion of the first portion 231F from both sides. Therefore, in a direction D3, the width of the second portion 232F is smaller than the width of the first portion 231F. In a direction D2, a length of the second portion 232F is greater than a length of the first portion 231F. In addition, in a cross section perpendicular to a longitudinal direction (direction D1) of the weight member 230F, a cross-sectional area of the first portion 231F is substantially equal to a cross-sectional area of the second portion 232F. The second portion 232F continues from an upper end to a lower end in the direction D2. That is, the second portion 232F is different from a configuration in which there are a concave portion or an opening in only a part of an area in the direction D2, such as an engraving or a fastening hole.

Similarly, in the direction D1, a mass per unit length of the first portion 231F and a mass per unit length of the second portion 232F are approximately equal. Further, as described above, since a portion of the first portion 231F is collapsed to form the second portion 232F, a mark collapsed by the presser used for compressing may be left on a main surface 2321F of the second portion 232F. On the other hand, a side surface 2322F of the second portion 232F is a portion that is stretched as a result of the main surface 2321F being collapsed during compressing. Therefore, a surface state of the main surface 2321F is different from a surface state of the side surface 2322F. As described above, the first portion 231 has a collapsed configuration and the second portion 232F having a relatively small thickness is provided at an end portion of the rod-shaped weight member 230F. As shown in FIG. 10, the second portion 232F is covered with the weight support member 250F.

As described above, when viewed from the direction perpendicular to the main surface 2321F of the second portion 232F (direction D3), the width of the second portion 232F is larger than the width of the first portion 231F in the direction D2 perpendicular to the direction D1 and the direction D3. When viewed from the direction D3, width of the direction D2 in the border portion 233F extends from the first portion 231F toward the second portion 232F in a curved manner. When viewed from the direction D3, a tip portion 2323F of the second portion 232F is curved. The curved shape of the tip portion 2323F is caused by the second portion 232F being formed by collapsing the first portion 231F having a circular cross-sectional shape in a plane perpendicular to the direction D1. In addition, the direction D3 corresponds to the scale direction of FIG. 10.

Although FIG. 11A to FIG. 11C show a configuration in which the cross-sectional shapes of the first portion 231F are circular, the configuration is not limited to this configuration. For example, the first portion 231F may have a flat cross-sectional shape. In FIG. 11A to FIG. 11C, the second portion 232F has a configuration in which a portion of the first portion 231F is collapsed in the scale direction, but is not limited to this configuration. For example, an end portion of the first portion 231F may be a longitudinally collapsed shape of the weight member 230F (a shape such as a head portion of a nail).

### [4-3. Modification]

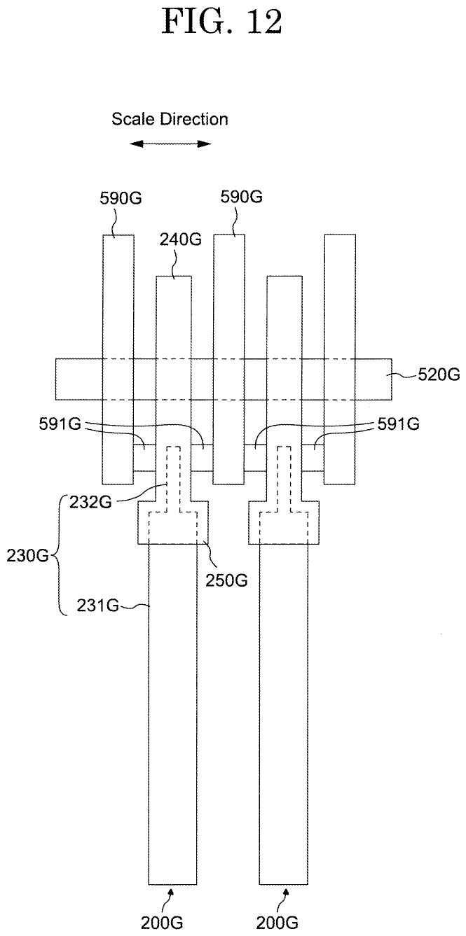

A modification of the fourth embodiment will be described with reference to FIG. 12 to FIG. 14. FIG. 12 to FIG. 14 are top views of a configuration in which a hammer assembly is attached to a frame in an embodiment of the present disclosure, respectively. Hammer assemblies 200G (Modification 1), 200H (Modification 2), and 200J (Modification 3) shown in FIG. 12 to FIG. 14 are similar to the hammer assembly 200F shown in FIG. 10. In the following description of the modification, the same features as those of the hammer assembly 200F of FIG. 10 will be omitted, and differences from the hammer assembly 200F will be mainly described. In the case of describing the same configuration as the fourth embodiment, with reference to FIG. 10 or other drawings, the following description will be described with alphabets “G” (Modification 1), “H” (Modification 2), and “J” (Modification 3) after the reference signs shown in these figures.

### [4-3-1. Modification 1]

The modification shown in FIG. 12 is different from the hammer assembly 200F in that a rib 590G is provided with a guide 591G for regulating the operation of the hammer assembly 200G. As shown in FIG. 12, the rib 590G is provided with the guide 591G protruding from the rib 590G toward the hammer assembly 200G. The guide 591G are provided in each of adjacent ribs 590G. The guide 591G is in contact with a weight support member 250G and slides with respect to the weight support member 250G in accordance with a rotation operation of the hammer assembly 200G. That is, the guide 591G restricts movements of the hammer assembly 200G in the scale direction. When viewed in the scale direction, the guide 591G overlaps a second part 232G. In the scale direction, a width of the weight support member 250G in an area corresponding to the second portion 232G is smaller than a width of the weight support member 250G in an area corresponding to a first portion 231G. The guide 591G is in contact with the weight support member 250G in an area of the weight support member 250G having a relatively smaller width in the scale direction. The guide 591G may be slidable relative to the weight support member 250G and may not be in contact at all times.

### [4-3-2. Modification 2]

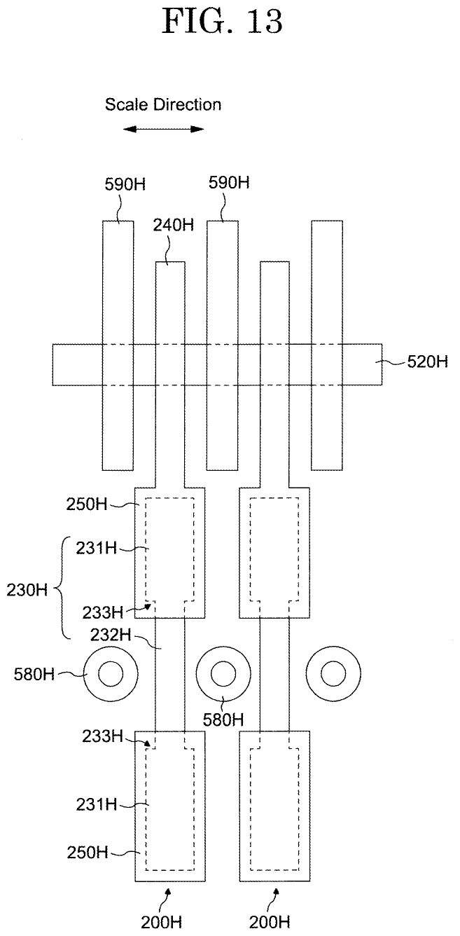

In the modification 2 shown in FIG. 13, a second portion 232H is provided in a vicinity of a center of a weight member 230H, and a first portion 231H is provided in an area including vicinities of both ends of the weight member 230H. That is, in the weight member 230H, the second portion 232H is sandwiched between the first portion 231H. In a longitudinal direction of a key 100H, a boss 580H is provided at a position away from a rib 590H. When viewed in the scale direction, the second portion 232H is provided at a position overlapping the boss 580H. A weight support member 250H is provided so as to cover the first portion 231H, and a portion of the second portion 232H is exposed from the weight support member 250H. The weight support member 250H is provided so as to cover a border portion 233H between the first portion 231H and the second portion 232H.

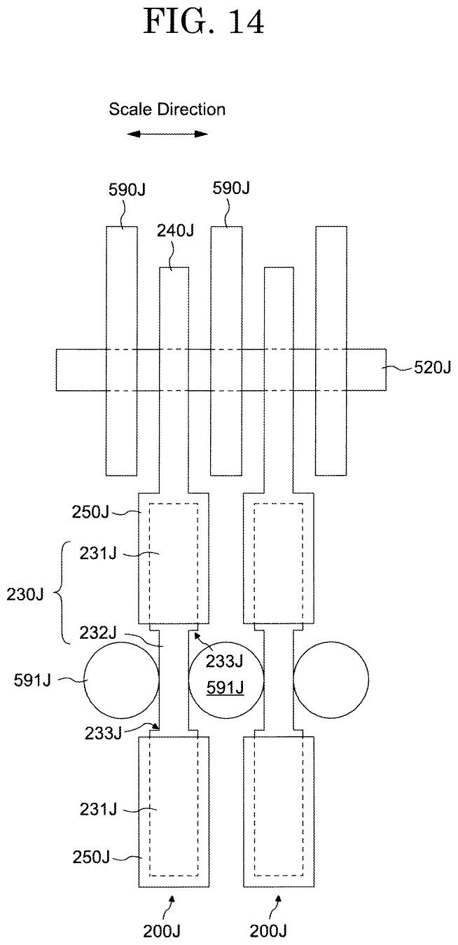

In the modification 2, although a configuration in which the boss 580H is provided at a position corresponding to the second portion 232H is exemplified, the configuration is not limited to this configuration. For example, the second portion 232H may be a member other than the boss 580H and may be provided at a position overlapping a member that may interfere with the hammer assembly 200H when viewed in the scale. As shown in FIG. 14, which will be described later, the weight support member 250H may not cover the border portion 233H. That is, a portion of the first portion 231H may be exposed from the weight support member 250H.

### [4-3-3. Modification 3]

Although the modification 3 shown in FIG. 14 is similar to the modification 2 shown in FIG. 13, modification 3 is different from the modification 2 shown in FIG. 13 in that a guide 591J is provided instead of the boss 580H shown in FIG. 13. The guide 591J is fixed with respect to a frame 500J. When viewed in the scale, a second portion 232J is provided at a position overlapping the guide 591J. In the scale direction, the second portion 232J is provided between two guides 591J. The guide 591J is in contact with the second portion 232J and slides with respect to the second portion 232J as the hammer assembly 200J rotates. That is, the guide 591J restricts movements of the hammer assembly 200J in the scale direction. The guide 591J may be slidable relative to the second portion 232J and may not be in contact at all times.

In the third modification, a portion of a first portion 231J is exposed from a weight support member 250J. That is, a border portion 233J is exposed from the weight support member 250J. However, as in the second modification, the border portion 233J may be covered with the weight support member 250J.

Keyboard apparatuses 1G, 1H, and 1J according to the modifications 1 to 3 can achieve the same advantages as the keyboard apparatus 1F according to the fourth embodiment.

### 5. Fifth Embodiment

### [5-1. Configuration of Weight Member 230K]

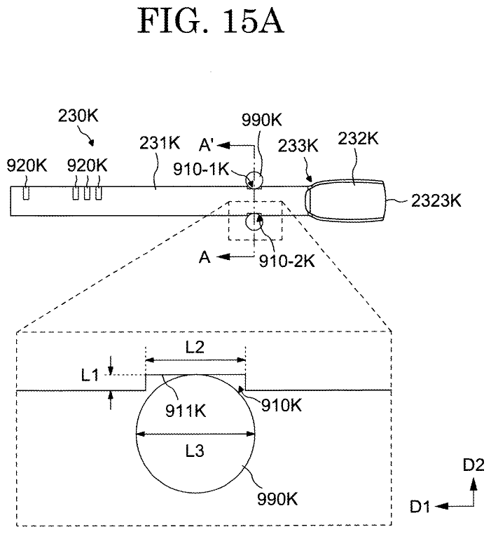

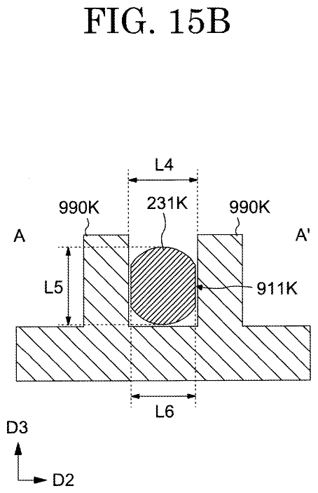

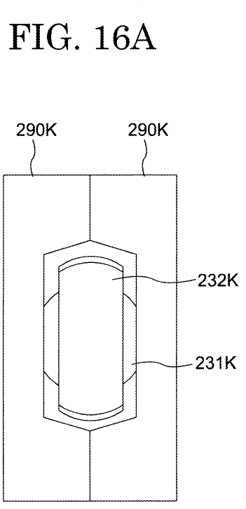

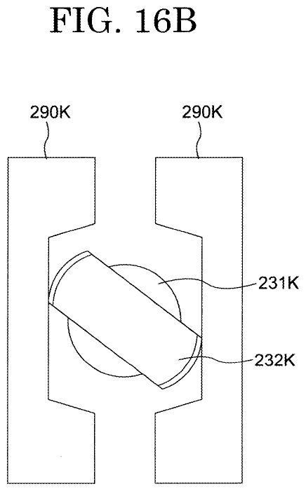

A fifth embodiment will be described with reference to FIG. 15A to FIG. 16B. FIG. 15A and FIG. 15B are a diagram showing an example of a weight member according to an embodiment of the present disclosure. FIG. 15A is a top view of a weight member 230K. FIG. 15B is a cross-sectional view taken along A-A′ line of FIG. 15A.

As shown in FIG. 15A, a first portion 231K of the weight member 230K is provided with a groove 910K and a marker portion 920K. In a top view, the groove 910K is recessed from both ends of the first portion 231K toward the inside of the first portion 231K in the direction D2. In other words, the groove 910K includes a first groove 910-1K and a second groove 910-2K. The first groove 910-1K is provided on the other side of the second groove 910-2K with respect to the weight member 230K. Although the groove 910K is provided in a portion of the first portion 231K, the groove 910K and the marker portion 920K are not provided in most of the areas of the first portion 231K, specifically, in an area of 75% or more. In this area, the first portion 231K has the same cross-sectional shape perpendicular to an extending direction.

An area surrounded by a dotted line in FIG. 15A is a partially enlarged view of an area of the first portion 231K where the groove 910K is provided. A width of the groove 910K in the direction D2 is L1. A depth of the groove 910K in the direction D1 is L2. A bottom portion 911K of the groove 910K is planar. However, the shape of the bottom portion 911K can be appropriately adjusted according to a shape of an alignment member 990K described later. For example, in the case where the shape of the alignment member 990K is a cylindrical shape, the shape of the bottom 911K may be an arc shape along an outer periphery of the cylindrical shape. In the present embodiment, although a configuration in which the groove 910K is provided at the both ends of the first portion 231K has been exemplified, the groove 910K may be provided only at one end of the first portion 231K.

The groove 910K is used as an alignment of the weight member 230K when a weight support member is resin-molded. Specifically, a position of a mold for resin-molding and a position of the alignment member 990K are fixed, and the weight member 230K is installed so that the groove 910K is arranged at the position of the alignment member 990K when the weight member 230K is installed with respect to the mold. FIG. 15A shows the weight member 230K positioned by the alignment member 990K. In the present embodiment, the alignment member 990K has a cylindrical shape, and a diameter of the cylindrical shape is L3. L3 is 3 mm or more, 5 mm or more, or 7 mm or more. In view of a strength of the alignment member 990K, L3 is preferably 3 mm or more. However, the shape of the alignment member 990K is not limited to the cylindrical shape, and various other shapes can be applied.

L1 is 0.2 mm or more, 0.3 mm or more, or 0.5 mm or more. In view of variations in the depth L1 of the groove 910K, variations in the position of the alignment member 990K, variations in a diameter of the first portion 231K, warpage of the first portion 231K, and the like, L1 is preferably 0.2 mm or more. L2 is 2 mm or more, 3 mm or more, or 5 mm or more. Considering that the diameter L3 of the alignment member 990K is 3 mm or more and that the depth L1 of the groove 910K is 0.2 mm or more, L2 is preferably 2 mm or more.

The marker portion 920K is provided at an end portion of the direction D2. The marker portion 920K is formed along a surface of the first portion 231K. For example, the marker portion 920K may be formed by roughening the surface of the first portion 231K. As described above, the groove 910K provides the planar bottom 911K, whereas the marker portion 920K does not provide such a plane, which is clearly distinct.

As shown in FIG. 15B, a distance L4 between an opposing alignment member 990K is smaller than a diameter L5 of a portion having a circular cross-sectional shape in the first portion 231K, and is larger than a distance L6 between two bottom portion 911K provided at the both ends of the first portion 231K in the direction D2. With the weight member 230K positioned by the alignment member 990K, the bottom portion 911K is in contact with or opposite to a side wall of the alignment member 990K. As shown in FIG. 15A, the weight member 230K is arranged so that the groove 910K is positioned between two alignment members 990K, so that a direction of a second portion 232K can be positioned in a certain direction.

FIG. 16A and FIG. 16B are a view showing a step of resin-molding a weight support member into a weight member according to an embodiment of the present disclosure. FIG. 16A is a diagram showing a condition in which the second portion 232K is in an appropriate direction, and the second portion 232K of the weight member 230K is sandwiched by a mold 290K for resin-molding a weight support member 250K. FIG. 16B is a diagram showing a condition in which the weight member 230K is sandwiched by the mold 290K in an improper direction of the second portion 232K. As shown in FIG. 16B, if the weight member 230K in a state in which the second part 232K is greatly inclined from a normal state (state shown in FIG. 16A) is sandwiched by the mold 290K, the mold 290K hits the second portion 232K, and there is a possibility that the mold 290K or the second portion 232K is damaged. However, as shown in FIG. 15A, by positioning the weight member 230K by the alignment member 990K, the condition as shown in FIG. 16B can be avoided.

In the embodiments described above, an electronic piano is shown as an example of a keyboard apparatus to which a hammer assembly is applied. A configuration in which the hammer assembly is provided with respect to a key has been exemplified. However, the hammer assembly of the embodiment described above may be applied to a device other than an electronic piano or a member other than a key of an electronic piano.

In addition, the present disclosure is not limited to the embodiments described above, and can be appropriately modified without departing from the spirit thereof. For example, the embodiment according to the present disclosure may have the following configuration.

According to an embodiment of the present disclosure, a keyboard apparatus including a frame, a first key, a second key, a first hammer assembly configured to rotate in accordance with movement of the first key, and a second hammer assembly configured to rotate in accordance with movement of the second key. The first hammer assembly has a first fixing member fixed to the frame, a first rotation member rotatably connected to the first fixing member with respect to a first center of rotation as a center of rotation, and a first weight member fixed to the first rotation member. The second hammer assembly has a second fixing member fixed to the frame, a second rotation member rotatably connected to the second fixing member with respect to a second center of rotation as a center of rotation, and a second weight member fixed to the second rotation member and has the same mass with the first weight member. A distance between a center of gravity of the first weight member and the first rotation axis is different from a distance between a center of gravity of the second weight member and the second rotation axis.

The first weight member and the second weight member may be the same shape.

The first weight member and the second weight member may be formed from the same material.

The first weight member and the second weight member may be rod-shapes.

Both the first key and the second key may be white keys or black keys.

The first fixing member may be a first axis portion, the second fixing member may be a second axis portion, the first rotation member may be a first bearing member, and the second rotation member may be a second bearing member.

The first bearing member may be different shape from the second bearing member.

According to an embodiment of the present disclosure, a keyboard apparatus including a frame, a first key, a second key, a first hammer assembly configured to rotate in accordance with movement of the first key and a second hammer assembly configured to rotate in accordance with movement of the second key. The first hammer assembly has a first fixing member fixed to the frame, a first rotation member rotatably connected to the first fixing member with respect to a first center of rotation as a center of rotation, and a first weight member fixed to the first rotation member, the first weight member being a rod-shape. The second hammer assembly has a second fixing member fixed to the frame, a second rotation member rotatably connected to the second fixing member with respect to a second center of rotation as a center of rotation, and a second weight member fixed to the second rotation member, the second weight member being a rod-shape. A cross section area of the first weight member perpendicular to an extending direction of the first weight member is substantially the same at positions in the extending direction of the first weight member, a cross section area of the second weight member perpendicular to an extending direction of the second weight member is substantially the same at positions in the extending direction of the second weight member, and the cross section area of the first weight member is different from the cross section area of the second weight member.

The keyboard apparatus may further comprise a first weight support member configured to cover and support one of edges of the first weight member, and a second weight support member configured to cover and support one of edges of the second weight member. A cross section area of the first weight member perpendicular to an extending direction of the first weight member exposed from the first weight support member may be substantially the same at positions in the extending direction of the first weight member, and a cross section area of the second weight member perpendicular to an extending direction of the second weight member exposed from the second weight support member may be substantially the same at positions in the extending direction of the second weight member.

In the case where the first weight member and the second weight member are viewed in a scale direction in which the first weight member and the second weight member are aligned, a first edge of a first center line of the first weight member in a far side from the first center of rotation may overlap a second edge of a second center line of the second weight member in a far side from the second center of rotation, and a third edge of the first center line in a near side of the first center of rotation may overlap a fourth edge of the second center line in a near side of the second center of rotation.

In the case where the first weight member and the second weight member are viewed in the scale direction in which the first weight member and the second weight member are aligned, a first rotational plane drawn by the first center line while rotary movement of the first hammer assembly may match a second rotational plane drawn by the second center line while rotary movement of the second hammer assembly.

In a graph in which a longitudinal direction of the first key and the second key is used as x-axis and linear densities of the first weight member and the second weight member are used as y-axis, a first graph indicating the linear density of an area corresponding to the first weight member and a second graph indicating the linear density of an area corresponding to the second weight member may be related by a constant multiple of one of the linear densities.

A distance between a center of gravity of the first weight member and the first center of rotation may be the same as a distance between a center of gravity of the second weight member and the second center of rotation.

The cross section area of the first weight member may be a cross section area in a cross section in direction in which a cross section area of the first weight member at a position in a longitudinal direction of the first weight member other than edges of the first weight member is the minimum, and the cross section area of the second weight member may be a cross section area in a cross section in direction in which a cross section area of the second weight member at a position in a longitudinal direction of the second weight member other than edges of the second weight member is the minimum.

A mass of the first weight member may be different from a mass of the second weight member.

The first weight member and the second weight member may be formed from the same material.

Both the first key and the second key may be white keys or black keys.

The first fixing member may be an axis portion, and the first rotation member may be a bearing member.

According to an embodiment of the present disclosure, a keyboard apparatus including a frame, a key, one or more hammer assemblies configured to rotate in accordance with movement of the key. The hammer assembly has a fixing member fixed to the frame, a rotation member rotatably connected to the fixing member with respect to the rotation axis as a center of rotation, a first weight member attached to the rotation member, and a second weight member attached to the rotation member. The first weight member is arranged in a rotational plane of the second weight member, and both the first weight member and the second weight member are arranged in the same side or an opposite side of a portion in which the key operates the hammer assembly with respect to the rotation axis.

The first weight member and the second weight member may be rod-shapes.

The first weight member and the second weight member may be arranged in non-parallel.

A shape of the first weight member may be the same as a shape of the second weight member.

The fixing member may be an axis portion, and the rotation member may be a bearing member.

According to the present disclosure, it is possible to provide a keyboard apparatus with a small manufacturing cost and a small workload.

What is claimed is:

1. A keyboard apparatus comprising:
a frame;
a first member;
a first key; and
a first hammer assembly configured to rotate in accordance with movement of the first key, and including:
a rotation member rotatably connected to the frame with respect to a rotation axis as a center of rotation; and
a weight member attached to the rotation member and including a first portion and a second portion,
wherein the second portion is disposed facing the first member in a first direction extending along the rotation axis,
wherein a thickness of the second portion is smaller than a thickness of the first portion, the thicknesses extending in the first direction, and
wherein a length of the second portion is larger than a length of the first portion in a rotation direction of the weight member.

2. The keyboard apparatus according to claim 1, further comprising:
a second key; and
a second hammer assembly configured to rotate in accordance with movement of the second key,
wherein the first member is:
fixed to a portion of the frame; and
arranged between the first and second hammer assemblies.

3. The keyboard apparatus according to claim 1, wherein the first member is a boss.

4. The keyboard apparatus according to claim 1, wherein the first member is a rib.

5. The keyboard apparatus according to claim 1, wherein the first member is a guide configured to restrict movement of the first hammer assembly in the first direction.

6. The keyboard apparatus according to claim 1, wherein:
the weight member is rod-shaped, and
the second portion includes an end edge of the weight member.

7. The keyboard apparatus according to claim 1, wherein:
the weight member is rod-shaped, and
the second portion is surrounded by the rotation member.

8. The keyboard apparatus according to claim 1, wherein the first portion of the weight member includes a groove with a flat surface at a bottom portion of the groove.

9. A keyboard apparatus comprising:
a frame;
a first member;
a first key; and
a first hammer assembly configured to rotate in accordance with movement of the first key, and including:
a rotation member rotatably connected to the frame with respect to a rotation axis as a center of rotation; and
a weight member attached to the rotation member and including a first portion and a second portion,
wherein the second portion is disposed facing the first member in a first direction extending along the rotation axis, and
wherein the second portion is thinner than the first portion in the first direction.

10. The keyboard apparatus according to claim 9, further comprising:
a second key; and
a second hammer assembly configured to rotate in accordance with movement of the second key;
the first member is:
fixed to a portion of the frame; and
arranged between the first and second hammer assemblies.

11. The keyboard apparatus according to claim 9, wherein the first member is a boss.

12. The keyboard apparatus according to claim 9, wherein the first member is a rib.

13. The keyboard apparatus according to claim 9, wherein the first member is a guide configured to restrict movement of the first hammer assembly in the first direction.

14. The keyboard apparatus according to claim 9, wherein:
the weight member is rod-shaped, and
the second portion includes an end edge of the weight member.

15. The keyboard apparatus according to claim 9, wherein:
the weight member is rod-shaped, and
the second portion is surrounded by the rotation member.

16. The keyboard apparatus according to claim 9, wherein the first portion of the weight member includes a groove with a flat surface at a bottom portion of the groove.
